(19) United States
(12) Patent Application Publication
(10) Pub. No.: US 2010/0254433 A1
(43) Pub. Date: Oct. 7, 2010

(54) Techniques to format a symbol for transmission

(76) Inventors: Shahrnaz Azizi, Portland, OR (US); Yang-Seok Choi, Portland, OR (US); Shailender Timiri, Vancouver, WA (US); Xinrong Wang, Beaverton, OR (US)

Correspondence Address: INTEL CORPORATION;c/o CPA Global, P.O. BOX 52050, MINNEAPOLIS, MN, 55402, US

(21) Appl. No.: 12/384,513

(22) Filed: Apr. 6, 2009

(51) Int. Cl. H04B 1/707; H04B 1/69

(52) U.S. Cl. 375/141; 375/130; 375/E01.002

(57) ABSTRACT

A symbol structure is disclosed for use at least with wireless signal transmitters. The symbol structure includes a symbol that is spread over at least two symbol time periods. The symbol may include at least two replicas of the same code. The subcarrier spacing of subcarriers of the symbol has a p/q ratio of the subcarrier spacing of an IEEE 802.16e symbol. In some cases, the symbol includes interspersed null values. The decoding of the symbol involves performing a Fourier transform on the symbol.

### FIELD

The subject matter disclosed herein relates generally to a transmitted symbol format.

### BACKGROUND ART

When a mobile station enters a wireless network, the mobile station uses an initial ranging process to establish a connection with a base station. In many cases, ranging symbols are transmitted by a mobile station during the initial ranging process.

FIG. 1 shows a well known prior art IEEE 802.16e ranging symbol format. Codes X and X+1 are OFDMA symbols. Code X is transmitted twice by a mobile user. Code X+1 will also be transmitted twice, if a base station allocates two consecutive initial ranging slots. The symbol format includes a replicate sample located at the end of code X in the cyclic prefix (CP) of code X and also includes a replicate sample at the beginning of another copy of code X at the guard region of the other copy of code X.

FIG. 2 depicts a symbol structure presented by LG Electronics (LGE) in contribution document C80216m-08_{—}978.pdf submitted to the evolving IEEE 802.16m standard (hereafter “LGE structure”). The LGE structure is for initial ranging in which OFDMA subcarrier spacing is shortened to allow spread of initial ranging sequences in time. The LGE structure allows for a longer sequence due to a longer spread in time but with the same bandwidth as that of the structure of FIG. 1. The longer sequence provides a better resolution in arrival time estimation and immunity to multiple access interference than that compared to the structure of FIG. 1. However, shorter subcarrier spacing may incur higher inter-carrier interference (ICI) power in a time varying channel.

In FIG. 2, ranging preamble (RP) represents a Ranging Channel. As shown in FIG. 2, code RP is extended over several OFDMA symbol durations in the time domain. In this example, assume code RP is extended over four OFDMA symbol durations in the time domain. In the symbol structure of FIG. 1, a symbol is extended over the frequency domain and there are 1024 samples per symbol. By contrast, in the symbol structure of FIG. 2, if we assume a symbol is extended over the time domain for four OFDM symbol durations, then there are 4096 samples per symbol. For a base station to record a preamble, the base station waits to receive all time samples of the code RP.

FIG. 3 demonstrates observed error floor due to the Inter Carrier Interference (ICI) for the symbol structure depicted with regard to FIG. 2. The ICI power impact can be much worse than shown in FIG. 3 if the near-far problem is considered in multiple access. The near-far problem is exhibited by users at different distances from a base station generating different received power at the base station.

It is desirable to have successful operation of initial ranging in a high speed mobile device to reduce error floor due to ICI.

### BRIEF DESCRIPTION OF THE DRAWINGS

Embodiments of the present invention are illustrated by way of example, and not by way of limitation, in the drawings and in which like reference numerals refer to similar elements.

FIGS. 1 and 2 depict prior art symbol structures.

FIG. 3 shows an observed error floor plot for the symbol structure described with regard to FIG. 2.

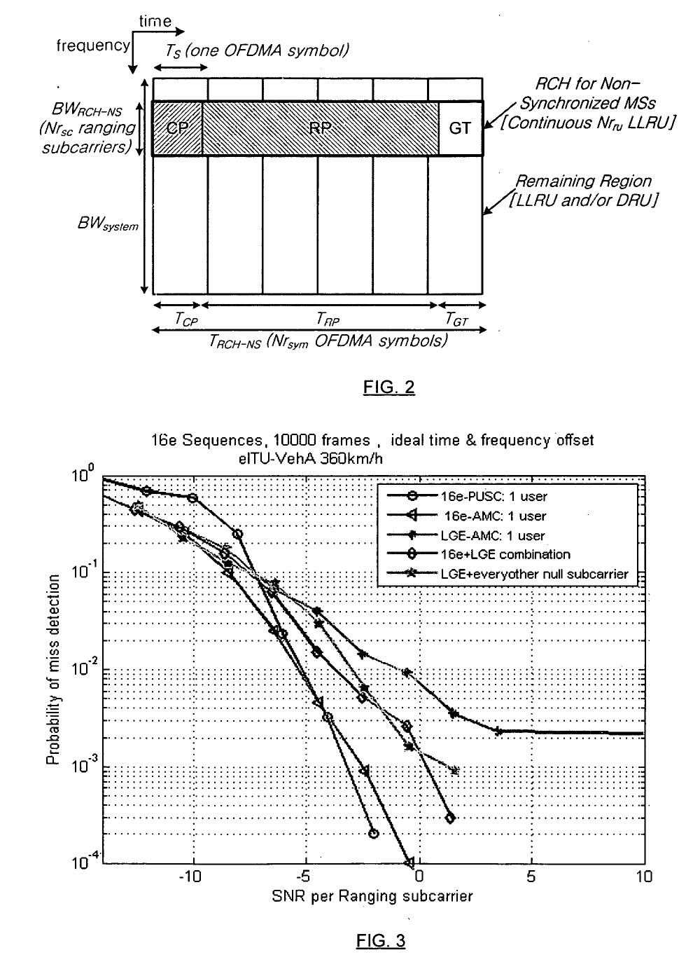

FIGS. 4A and 4B show symbol structures in accordance with embodiments of the present invention.

FIG. 5 depicts a wireless communication system, in accordance with an embodiment.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital-Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing IEEE 802.11, 802.11a, 802.11b, 802.11e, 802.11g, 802.11 h, 802.11i, 802.11n, 802.16, 802.16d, 802.16e, 802.16m, or 3GPP standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a. Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency Division Multiple Access (OFDMA), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth®, ZigBee™, or the like. Embodiments of the invention may be used in various other apparatuses, devices, systems and/or networks. IEEE 802.11x may refer to any existing IEEE 802.11 specification, including but not limited to 802.11a, 802.11b, 802.11e, 802.11g, 802.11 h, 802.11i, and 802.11n.

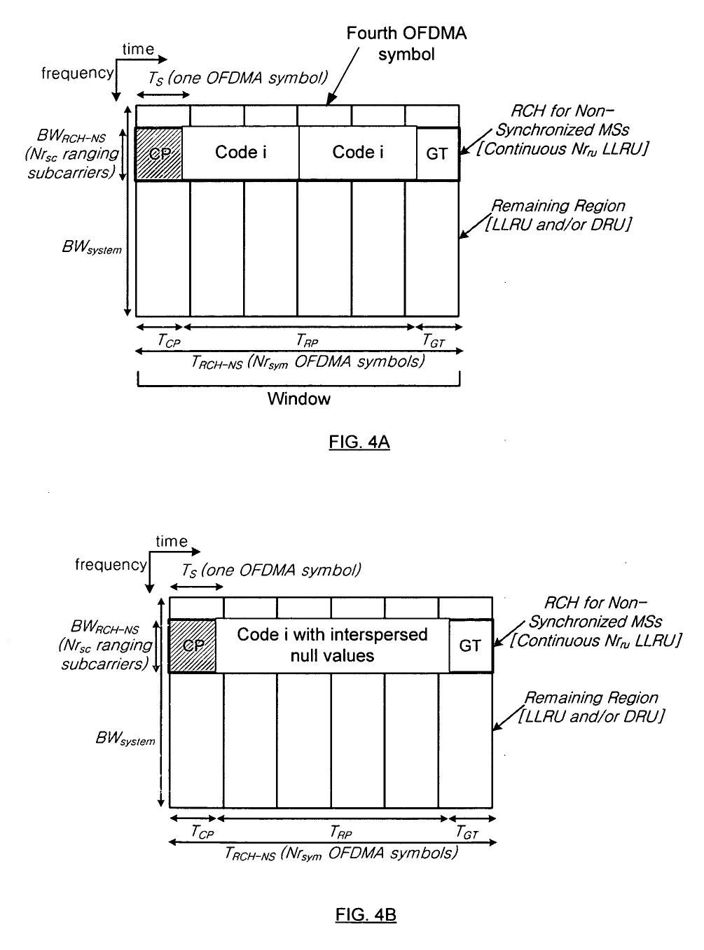

Reducing a symbol duration or increasing subcarrier spacing reduces the integration time interval in a fast Fourier transform (FFT) operation at a symbol receiver. Reducing the integration time interval in the FFT operation at a symbol receiver reduces ICI power. FIGS. 4A and 4B provide various embodiments of symbol structures useful at least during initial ranging that can mitigate ICI and to decrease the probability of miss detection. For example, the structures described with regard to FIGS. 4A and 4B may decrease the probability of miss detection to the point that error floor may be less than 1/10,000.

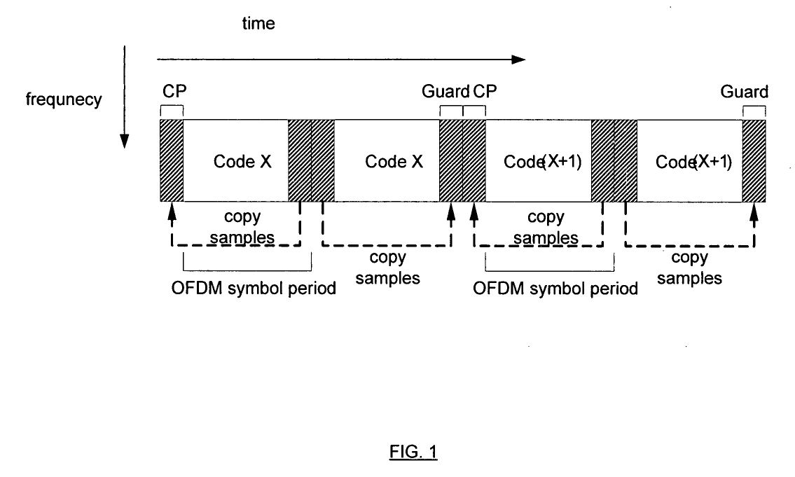

FIG. 4A depicts a symbol structure, in accordance with an embodiment. The symbol structure of FIG. 4A is similar to that of FIG. 2 except that symbol Code i of FIG. 4A is repeated twice during the duration of symbol RP of FIG. 2. In the structure of FIG. 4A, a ranging sequence r_{0,i}, r_{1,i}, . . . , r_{N-2,j}, r_{N-1,i} is mapped to N subcarriers in the frequency domain having a subcarrier spacing of p/q, p, q ε N (N is a natural number) of the IEEE 802.16e subcarrier spacing of FIG. 1. A ranging sequence may include a series of numbers (e.g., +1, −1) assigned to the frequency domain. Subcarrier spacing is a spacing between subcarriers of a symbol.

For example, the subcarrier spacing of the symbol of FIG. 4A, p/q, may be 2/5 of the IEEE 802.16e subcarrier spacing of the structure of FIG. 1. Reducing the subcarrier spacing allows for higher number of subcarriers in a given bandwidth that in turn allows a larger size IFFT and therefore leads to more time samples spread over time than that compared to the structure of FIG. 1. Consequently, a longer time symbol “Code i” is generated after IFFT operation than that compared to the structure of FIG. 1. A single occurrence of “Code i” has

$$\frac{{T}_{RP}}{2}$$

time samples, where T_{RP} represents a ranging preamble duration. Because Code i is repeated twice in time, the denominator of T_{RP} is 2.

A number of subcarriers N is defined as N≦Nr_{SC}, where Nr_{SC} is a number of ranging subcarriers. A number of ranging subcarriers encompasses subcarriers allocated to ranging including unused guard band subcarriers allowing some subcarriers to be used as guard band to control interference with multiplexed data across the bandwidth of the system, BW_{system}. In the evolving IEEE 802.16m standard, the BW_{system} can be 10 or 20 MHz.

The long CP proposed by the LGE structure may maintain signal orthogonality despite the existence of propagation delay related to the maximum delay spread and round trip delay (RTD) for given cell size. Repetition of “Code i” as shown in FIG. 4A mitigates ICI and provides a mechanism to support a very large cell size. As long as a total duration of RTD and delay spread (DS) is less than CP plus duration of “Code i”, then the base station still receives “Code i” in fourth and fifth OFDM symbols. By using timing offset estimation techniques, the base station will be able to detect a ranging sequence successfully. For example, timing offset estimation techniques can be as follows. A base station can operate on nominal range or normal timing offset estimation while buffering samples of the ranging channel. If nothing is detected, the base station can then operate in extended-range mode thereby using the buffered sample to perform time domain cross-correlation for timing offset estimation.

In extended range mode, the round trip delay increases, so a transmitted signal from a base station reaches a mobile station after a considerable delay and a transmitted signal from a mobile station reaches a base station after a considerable delay. The delay may be more than a duration of Code i. The base station has a window to process ranging symbols that is shown in FIG. 4A. Higher delay causes the ranging information to slide out of the window. The base station may start looking for a ranging sequence from the beginning of the window but Code i is not detected until the fourth and fifth OFDM symbols.

In the case of a large cell size, repeating Code i enables detection of at least one instance of Code i. In some embodiments, more than two repetitions of Code i can be made. In such embodiments, a duration of Code i may be reduced. However, reducing the duration of Code i may reduce the performance of its signal-to-noise ratio to an unacceptable level. Repeating Code i more than twice may potentially increase the size of the cell.

Note that if the sum of RTD and DS is larger than guard time (GT), then the ranging sequence will cause interference to the next subframe. The interference impact may be negligible if ranging is transmitted by a far away user (large value of RTD) whose signal is considerably attenuated. If the ranging structures described with regard to FIGS. 4A and 4B are used with timing offset estimation in the frequency domain, then cell sizes up to 33 km in radius may be supported. By comparison, the structure described with regard to FIG. 1 for IEEE 802.16e may support up to 12 km radius cell with code detection and timing offset estimation performed in the frequency domain.

FIG. 4B depicts another structure that includes code i inserted once with null subcarriers inserted between ranging subcarriers. For example, the null subcarriers can be inserted between every other ranging subcarrier or in a manner such that there are enough null subcarriers to spread the ranging subcarriers over the duration of code RP of FIG. 2. Accordingly, the ranging subcarriers may be represented as: r_{0,i}, 0, r_{1,i}, 0, . . . , r_{15,i}, 0, r_{16,i}, 0. The inserted null subcarriers create a repeated time domain signal with the same period

$$( \frac{{T}_{RP}}{2} )$$

as that of the structure depicted in FIG. 4A. A property of IFFT is if every other subcarrier is null, then the time domain signal has symmetrical structure. By inserting M−1 null subcarriers, the time domain signal will repeat M times over T_{RP} duration with period of

$$\frac{{T}_{RP}}{M} .$$

By using the FFT with M times smaller FFT size, the normalized Doppler frequency can be M times smaller, thereby resulting in smaller ICI power.

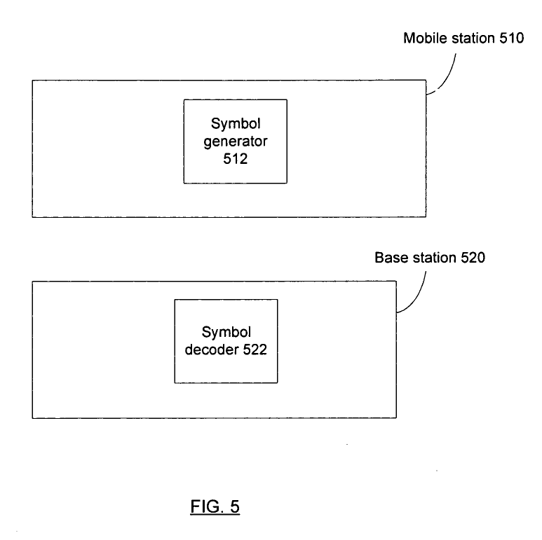

FIG. 5 depicts a wireless communication system, in accordance with an embodiment. Mobile station 510 includes symbol generator 512 that generates a symbol in conformance with the structures described with regard to FIG. 4A or 4B. The symbol carries data or other information for transmission to base station 520 and can be used at least during initial ranging. Base station 520 includes a symbol decoder 522 that is capable of decoding symbols having a structure described with regard to FIG. 4A or 4B and can be used to establish a connection between mobile station 510 and base station 520 during initial ranging.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method comprising:
forming a symbol that is spread over at least two symbol time periods, wherein a subcarrier spacing of subcarriers of the symbol comprises a ratio of the subcarrier spacing of an IEEE 802.16e symbol;
generating a signal that carries the symbol; and
transmitting the symbol over a wireless medium.

2. The method of claim 1, wherein the symbol is spread over two symbol time periods.

3. The method of claim 1, wherein the symbol includes at least two replicas of the same code.

4. The method of claim 3, wherein a reception distance of a receiver of the transmitted symbol is based in part on a number of replicas of the same code.

5. The method of claim 1, wherein the symbol includes null codes.

6. The method of claim 1, wherein the symbol includes null codes interspersed between every other ranging subcarrier.

7. The method of claim 1, wherein the ratio is 2/5.

8. The method of claim 1, wherein the ratio is less than one.

9. A method comprising:
decoding a symbol, wherein the symbol is spread over at least two symbol time periods, wherein a subcarrier spacing of subcarriers of the symbol comprises a ratio of the subcarrier spacing of an IEEE 802.16e symbol and wherein the ratio is less than one.

10. The method of claim 9, wherein the decoding comprises performing a Fourier transform on the symbol.

11. The method of claim 9, wherein the symbol includes at least two replicas of the same code.

12. The method of claim 9, wherein the symbol includes null codes.

13. The method of claim 9, wherein the symbol includes null codes interspersed between every other ranging subcarrier.

14. An apparatus comprising:
logic to form a symbol that is spread over at least two symbol time periods, wherein a subcarrier spacing of subcarriers of the symbol comprises a ratio of the subcarrier spacing of an IEEE 802.16e symbol and wherein the ratio is less than one;
logic to generate a signal that conveys the symbol; and
logic to transmit the symbol over a wireless medium.

15. The apparatus of claim 14, wherein the symbol includes at least two replicas of the same code.

16. The apparatus of claim 14, wherein the symbol includes null codes.

17. A system comprising:
a mobile station comprising:
logic to form a symbol that is spread over at least two symbol time periods, wherein a subcarrier spacing of subcarriers of the symbol comprises a ratio of the subcarrier spacing of an IEEE 802.16e symbol and wherein the ratio is less than one and
logic to transmit the symbol;
a base station comprising:
logic to receive the symbol and
logic to decode the symbol using a Fourier transform.

18. The system of claim 17, wherein the symbol includes at least two replicas of the same code.

19. The system of claim 17, wherein the symbol includes null codes.

20. The system of claim 17, wherein the symbol includes null codes interspersed between every other ranging subcarrier.
